(19) United States
(12) Patent Application Publication
(10) Pub. No.: US 2021/0402992 A1
(43) Pub. Date: Dec. 30, 2021

(54) APPARATUS AND METHOD FOR SETTING PLANNED TRAJECTORY

(71) Applicant: TOYOTA JIDOSHA KABUSHIKI KAISHA, Toyota-shi (JP)

(72) Inventors: Shuichi MORIMOTO, Tokyo-to (JP); Yuta ASAKA, Tokyo-to (JP); Wataru MINOURA, Tokyo-to (JP); Shun FUJIOKA, Tokyo-to (JP); Takashi IENAGA, Tokyo-to (JP); Takahiro OZAKI, Tokyo-to (JP)

(21) Appl. No.: 17/358,655

(22) Filed: Jun. 25, 2021

(30) Foreign Application Priority Data
Jun. 30, 2020 (JP) 2020-113294

(51) Int. Cl. B60W 30/12; G06K 9/00

(52) U.S. Cl. CPC B60W 30/12; B60W 2552/53; B60W 2420/42; G06K 9/00798

(57) ABSTRACT

An apparatus for setting a planned trajectory includes a processor configured to identify a travel lane on which a vehicle is traveling, detect, as a specific section, a section lacking at least one of left and right lane lines of the travel lane of the vehicle in a planned travel section, set at least one candidate of a planned trajectory to be traveled by the vehicle in the specific section, the at least one candidate including a candidate based on an existing one of the lane lines or a road edge, and set, of the set candidate, a candidate having a minimum variation in curvature or a minimum offset distance in a direction perpendicular to a travel direction of the vehicle at parts connected to the planned trajectory in sections ahead of and behind the specific section as the planned trajectory of the specific section.

### FIELD

The present invention relates to an apparatus and a method for setting a trajectory to be traveled by a vehicle.

### BACKGROUND

Techniques to automatically drive a vehicle have been researched. Such a technique controls travel of a vehicle, based on a lane line, so that an automatically driven vehicle may travel along a lane. However, some roads may lack one of left and right lane lines of a travel lane of a vehicle. Therefore techniques have been proposed to appropriately control travel of a vehicle even if one of left and right lane lines does not exist (see, e.g., International Publication No. 2011/064825 and Japanese Unexamined Patent Publications Nos. 2015-165368, 2016-206895, and 2017-520056).

For example, International Publication No. 2011/064825 describes a technique in which a driving support ECU uses an image taken by a camera and representing a travel road surface ahead of a vehicle to detect a lane-dividing line on the travel road surface and to set a virtual lane-dividing line in a section lacking a lane-dividing line. The driving support ECU controls the vehicle to support driving, based on the lane-dividing line and the virtual lane-dividing line, and issues a warning when the vehicle crosses the virtual lane-dividing line.

Japanese Unexamined Patent Publication No. 2015-165368 describes a technique in which a lane line recognition apparatus detects left and right white lane lines, based on an image captured by a camera mounted on a vehicle, determines whether a width of a road is abnormal, based on the detected left and right white lane lines, and recognizes one of the lane lines in a one-side line recognition mode when it is determined that the width is abnormal. In the one-side line recognition mode, this apparatus calculates two or more of parameters representing relative positions of the vehicle and parameters representing the shapes of the lane lines, based on the detected lane lines, integrates results of recognition obtained using the calculated parameters, and selects one of the left and right white lane lines to be recognized.

Japanese Unexamined Patent Publication No. 2016-206895 describes a technique in which, when one of left and right white lines becomes unrecognizable, a white line follow-up travel controller guides a vehicle so as to keep a certain distance from the recognized white line on the side of the unrecognized white line. This distance is by a predetermined shift amount smaller than a half of that width between the left and right white lines which has been calculated based on recognition of the white lines.

Japanese Unexamined Patent Publication No. 2017-520056 describes a technique in which a look-ahead lane width and a near lane width are computed based on left and right lane boundaries. A lane width increase is computed to detect a lane split or lane merge, based on differences between increasing lane widths. The lane boundary on the side on which the lane split or merge occurred is ignored, and a single-sided lane centering calculation is performed based on the non-ignored lane boundary.

### SUMMARY

In the above-described techniques, a trajectory to be traveled by a vehicle (hereafter simply a “planned trajectory”) under automated driving control may not be a smooth trajectory along the lane on which the vehicle is traveling (hereafter, the “host vehicle lane”) in a section lacking one or both of left and right lane lines of the host vehicle lane and the sections ahead of and behind this section.

It is an object of the present invention to provide an apparatus that can set a smooth planned trajectory along the host vehicle lane even if a section lacks one or both of left and right lane lines of the host vehicle lane.

According to an embodiment, an apparatus for setting a planned trajectory is provided. The apparatus includes a processor configured to identify a travel lane on which a vehicle is traveling, detect, as a specific section, a section lacking at least one of left and right lane lines of the travel lane of the vehicle in a planned travel section from a current position of the vehicle to a position a predetermined distance ahead thereof, set at least one candidate of a planned trajectory to be traveled by the vehicle in the specific section, the at least one candidate including a candidate based on an existing one of the lane lines or a road edge, and set, of the set candidate, a candidate having a minimum variation in curvature or a minimum offset distance in a direction perpendicular to a travel direction of the vehicle at parts connected to the planned trajectory in sections ahead of and behind the specific section as the planned trajectory of the specific section.

Preferably, the processor detects, as the specific section, a one-sided-line section in which one of left and right lane lines of the travel lane of the vehicle is broken. In the one-sided-line section, the processor sets the at least one candidate including a first candidate set at a position a first offset distance closer to the center of the travel lane from an unbroken one of left and right lane lines, and sets, of the set candidate, a candidate having a minimum variation in curvature or a minimum offset distance in a direction perpendicular to a travel direction of the vehicle at parts connected to the planned trajectory in sections ahead of and behind the one-sided-line section as the planned trajectory of the one-sided-line section.

Preferably, the processor further detects, as the specific section, a lack-of-line section in which both of left and right lane lines of the travel lane of the vehicle are broken. In the lack-of-line section, the processor sets the plurality of candidates including a first candidate and a second candidate, the first candidate being set at a position a second offset distance closer to the center of a road being traveled by the vehicle from the left edge of the road, the second candidate being set at a position the second offset distance closer to the center of the road from the right edge of the road, and sets, of the set candidates, a candidate having a minimum variation in curvature or a minimum offset distance in a direction perpendicular to a travel direction of the vehicle at parts connected to the planned trajectory in sections ahead of and behind the lack-of-line section as the planned trajectory of the lack-of-line section.

In the case that the one-sided-line section and the lack-of-line section connect, it is more preferable that the processor sets the planned trajectory of the one-sided-line section earlier than the planned trajectory of the lack-of-line section.

Preferably, the processor further detects a widened section in which the travel lane has a width greater than a predetermined width threshold. In the widened section, the processor sets the plurality of candidates including a first candidate and a second candidate, the first candidate being set at a position a third offset distance closer to the center of the travel lane of the vehicle from a left lane line of the travel lane, the second candidate being set at a position the third offset distance closer to the center of the travel lane of the vehicle from a right lane line of the travel lane, and sets, of the set candidates, a candidate having a minimum variation in curvature or a minimum offset distance in a direction perpendicular to a travel direction of the vehicle at parts connected to the planned trajectory in sections ahead of and behind the widened section as the planned trajectory of the widened section.

Preferably, in the planned travel section, the processor further detects a merge or split section in which the travel lane of the vehicle and another lane merge or split. In the merge or split section, the processor sets the planned trajectory at a position a fourth offset distance closer to the center of the travel lane from a lane line or a road edge opposite to the other lane.

According to another embodiment, a method for setting a planned trajectory is provided. The method includes identifying a travel lane on which a vehicle is traveling; detecting, as a specific section, a section lacking at least one of left and right lane lines of the travel lane of the vehicle in a planned travel section from a current position of the vehicle to a position a predetermined distance ahead thereof; setting at least one candidate of a planned trajectory to be traveled by the vehicle in the specific section, the at least one candidate including a candidate based on an existing one of the lane lines or a road edge; and setting, of the set candidate, a candidate having a minimum variation in curvature or a minimum offset distance in a direction perpendicular to a travel direction of the vehicle at parts connected to the planned trajectory in sections ahead of and behind the specific section as the planned trajectory of the specific section.

The apparatus according to the present invention has an advantageous effect of being able to set a smooth planned trajectory along the host vehicle lane even if a section lacks one or both of left and right lane lines of the host vehicle lane.

### BRIEF DESCRIPTION OF DRAWINGS

FIG. 1 schematically illustrates the configuration of a vehicle control system including an apparatus for setting a planned trajectory.

FIG. 2 illustrates the hardware configuration of an electronic control unit, which is an embodiment of the apparatus for setting a planned trajectory.

FIG. 3 is a functional block diagram of a processor of the electronic control unit, related to a vehicle control process including a planned-trajectory setting process.

FIG. 4A illustrates an example of detection of a one-sided-line section and a lack-of-line section.

FIG. 4B illustrates an example of detection of a one-sided-line section and a lack-of-line section.

FIG. 4C illustrates an example of detection of a one-sided-line section and a lack-of-line section.

FIG. 5 illustrates an example of a widened section.

FIG. 6 is a diagram for explaining setting of planned trajectories of a one-sided-line section and a lack-of-line section.

FIG. 7 is a diagram for explaining setting of a planned trajectory of a widened section.

FIGS. 8A and 8B are an operation flowchart of the vehicle control process including the planned-trajectory setting process.

FIG. 9 illustrates an example of a planned trajectory of a merge or split section according to a modified example.

### DESCRIPTION OF EMBODIMENTS

Hereinafter, an apparatus for setting a planned trajectory and a method therefor executed by the apparatus will be described with reference to the accompanying drawings. The apparatus sets a trajectory to be traveled by a vehicle (hereafter simply a “planned trajectory”), which is defined as a set of positions on a road, in a planned travel section from the current position of the vehicle to a position a predetermined distance ahead thereof. To this end, the apparatus detects sections lacking one of left and right lane lines of the host vehicle lane (hereafter, “one-sided-line sections”) and sections lacking both of left and right lane lines of the host vehicle lane (hereafter, “lack-of-line sections”). For each one-sided-line section, the apparatus sets one of candidate trajectories at a position a predetermined offset distance closer to the center of the host vehicle lane from an existing one of the lane lines. For each lack-of-line section, the apparatus detects the left and right edges of the road on which the vehicle is traveling, and sets candidate trajectories so as to include a candidate of the planned trajectory based on the left edge and a candidate thereof based on the right edge. Of the set candidates, the apparatus sets, for each one-sided-line section and lack-of-line section, a candidate trajectory having a minimum variation in curvature or a minimum offset at parts connected to the planned trajectory in sections ahead of and behind this section as the planned trajectory of the one-sided-line section or the lack-of-line section.

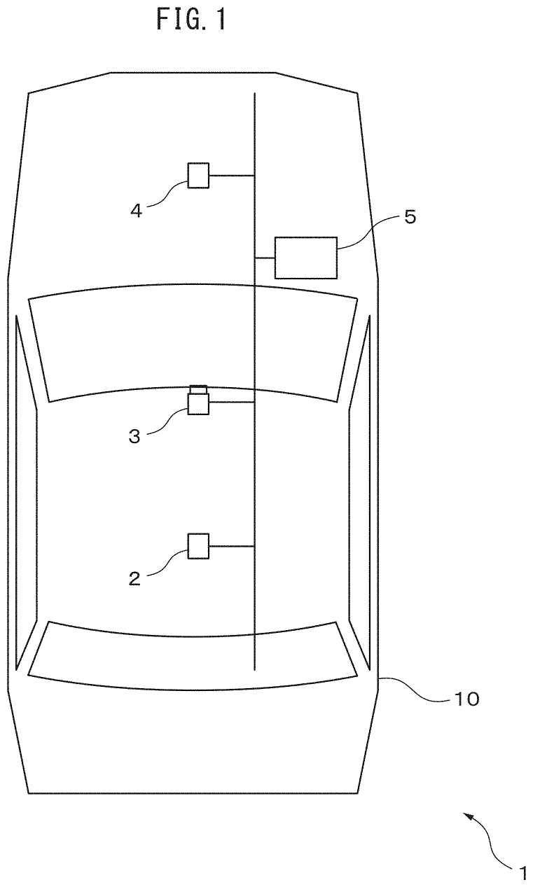

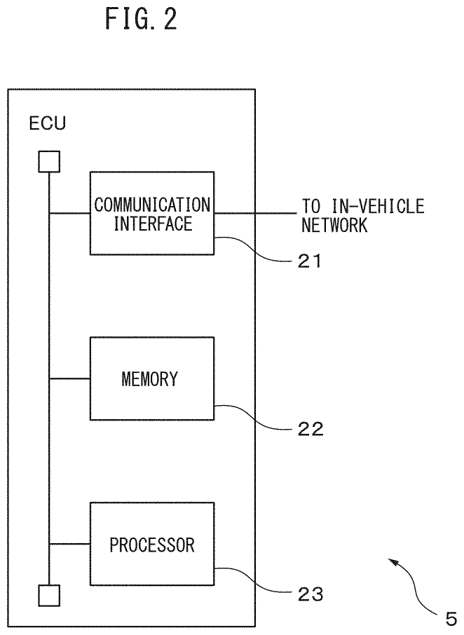

FIG. 1 schematically illustrates the configuration of a vehicle control system including an apparatus for setting a planned trajectory. FIG. 2 illustrates the hardware configuration of an electronic control unit, which is an embodiment of the apparatus for setting a planned trajectory. In the present embodiment, a vehicle control system 1, which is mounted on a vehicle 10 and controls the vehicle 10, includes a GPS receiver 2, a camera 3, a storage device 4, and an electronic control unit (ECU) 5, which is an example of the apparatus for setting a planned trajectory. The GPS receiver 2, the camera 3, and the storage device 4 are connected to the ECU 5 via an in-vehicle network conforming to a standard, such as a controller area network, so that they can communicate with each other. The vehicle control system 1 may further include a distance sensor (not illustrated), such as LiDAR or radar, which measures the distance from the vehicle 10 to an object around the vehicle 10. The vehicle control system 1 may further include a navigation device (not illustrated) for searching for a planned travel route to a destination. The vehicle control system 1 may further include a wireless communication device (not illustrated) for wireless communication with another device.

The GPS receiver 2 receives a GPS signal from a GPS satellite every predetermined period, and determines the position of the vehicle 10, based on the received GPS signal. The GPS receiver 2 outputs positioning information indicating the result of determination of the position of the vehicle 10 based on the GPS signal to the ECU 5 via the in-vehicle network every predetermined period. The vehicle 10 may include a receiver conforming to a satellite positioning system other than the GPS receiver 2. In this case, this receiver determines the position of the vehicle 10.

The camera 3, which is an example of an image capturing unit, includes a two-dimensional detector constructed from an array of optoelectronic transducers, such as CCD or C-MOS, having sensitivity to visible light and a focusing optical system focusing an image of a target region on the two-dimensional detector. The camera 3 is mounted, for example, in the interior of the vehicle 10 so as to be oriented, for example, to the front of the vehicle 10. The camera 3 captures a region in front of the vehicle 10 every predetermined capturing period (e.g., 1/30 to 1/10 seconds), and generates images in which this region is captured. The images obtained by the camera 3 may be color or gray images. The vehicle 10 may include multiple cameras taking pictures in different orientations or having different focal lengths.

Every time generating an image, the camera 3 outputs the generated image to the ECU 5 via the in-vehicle network.

The storage device 4, which is an example of a storage unit, includes, for example, a hard disk drive, a nonvolatile semiconductor memory, or an optical recording medium and an access device therefor. The storage device 4 stores a high-precision map, which is an example of map information. The high-precision map includes, for example, information indicating the presence or absence of lane lines and the positions thereof and information indicating road edges (e.g., the distance from the center of a road to a road edge and the positions of curbstones) at locations on roads included in a predetermined region represented in the high-precision map. The high-precision map may further include information indicating road markings other than lane lines, such as stop lines, and information indicating signposts.

The storage device 4 may further include a processor for executing, for example, a process to update the high-precision map and a process related to a request from the ECU 5 to read out the high-precision map. For example, every time the vehicle 10 moves a predetermined distance, the storage device 4 may transmit the current position of the vehicle 10 and a request to acquire the high-precision map to a map server via a wireless communication device (not illustrated), and receive a high-precision map of a predetermined region around the current position of the vehicle 10 from the map server via the wireless communication device. When receiving a request from the ECU 5 to read out the high-precision map, the storage device 4 cuts out that portion of the high-precision map stored therein which includes the current position of the vehicle 10 and which represents an area smaller than the predetermined region, and outputs the cut portion to the ECU 5 via the in-vehicle network.

The ECU 5 controls travel of the vehicle 10 so as to automatically drive the vehicle 10.

As illustrated in FIG. 2, the ECU 5 includes a communication interface 21, a memory 22, and a processor 23. The communication interface 21, the memory 22, and the processor 23 may be separate circuits or a single integrated circuit.

The communication interface 21 includes an interface circuit for connecting the ECU 5 to the in-vehicle network. Every time receiving positioning information from the GPS receiver 2, the communication interface 21 passes the positioning information to the processor 23. Every time receiving an image from the camera 3, the communication interface 21 passes the received image to the processor 23. Additionally, the communication interface 21 passes the high-precision map loaded from the storage device 4 to the processor 23.

The memory 22, which is another example of a storage unit, includes, for example, volatile and nonvolatile semiconductor memories. The memory 22 stores various types of data used in a planned-trajectory setting process executed by the processor 23 of the ECU 5. For example, the memory 22 stores images of surroundings of the vehicle 10, the result of determination of the position of the vehicle, the high-precision map, internal parameters of the camera 3, such as parameters indicating its focal length, angle of view, orientation, and mounted position, and a set of parameters for specifying a classifier used for detecting, for example, lane lines. Additionally, the memory 22 temporarily stores various types of data generated during the planned-trajectory setting process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes a vehicle control process for the vehicle 10.

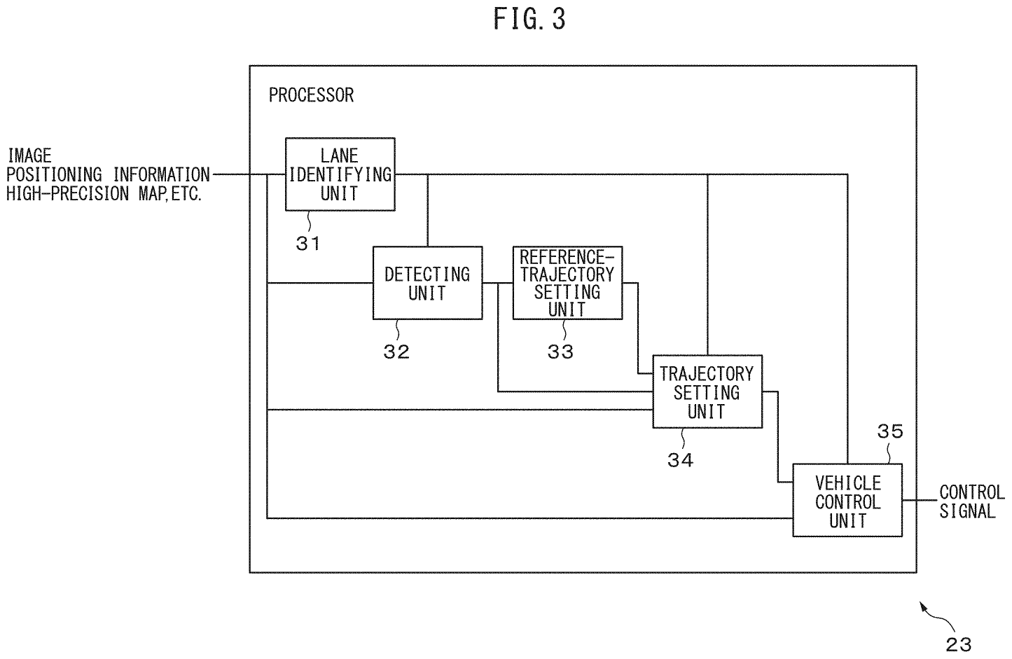

FIG. 3 is a functional block diagram of the processor 23, related to the vehicle control process including the planned-trajectory setting process. The processor 23 includes a lane identifying unit 31, a detecting unit 32, a reference-trajectory setting unit 33, a trajectory setting unit 34, and a vehicle control unit 35. These units included in the processor 23 are, for example, functional modules implemented by a computer program executed on the processor 23, or may be dedicated operating circuits provided in the processor 23.

The lane identifying unit 31 identifies the lane on which the vehicle 10 is traveling (hereafter, the “host vehicle lane”) every predetermined period. For example, the lane identifying unit 31 identifies the road on which the vehicle 10 is traveling by referring to the current position of the vehicle 10 measured by the GPS receiver 2 and the high-precision map, and identifies a lane of the identified road on which the vehicle 10 can travel as the host vehicle lane. For example, in the case that the road at the current position of the vehicle 10 is a left-hand traffic road with one lane in each direction, the lane identifying unit 31 identifies the left lane with respect to the travel direction of the vehicle 10 as the host vehicle lane.

Alternatively, the lane identifying unit 31 may compare an image obtained by the camera 3 with the high-precision map to identify the host vehicle lane. In this case, for example, the lane identifying unit 31 inputs the image into a classifier to detect features on or around the road represented in the image (e.g., lane lines, curbstones of road edges, and signposts). As such a classifier, the lane identifying unit 31 may use, for example, a deep neural network (DNN) having a convolutional neural network (CNN) architecture, such as a Single Shot MultiBox Detector (SSD) or a Faster R-CNN. Such a classifier is trained in advance to detect a sensing-target feature from an image. The lane identifying unit 31 temporarily sets the position and orientation of the vehicle 10, and projects features on the road detected from an image onto the high-precision map by referring to internal parameters of the camera 3, or projects features on the road around the vehicle 10 in the high-precision map onto the image. The lane identifying unit 31 then estimates the current position and orientation of the vehicle 10 to be the position and orientation of the vehicle 10 for the case that features on the road detected from the image best match with features on the road represented in the high-precision map. Of the lanes represented in the high-precision map, the lane identifying unit 31 may identify the lane including the estimated current position of the vehicle 10 as the host vehicle lane.

The lane identifying unit 31 notifies information indicating the identified host vehicle lane and information indicating the current position of the vehicle 10 to the detecting unit 32, the reference-trajectory setting unit 33, the trajectory setting unit 34, and the vehicle control unit 35.

Every time receiving the information indicating the host vehicle lane and the information indicating the current position of the vehicle 10 from the lane identifying unit 31, the detecting unit 32 detects specific sections lacking at least one of left and right lane lines, i.e., one-sided-line sections and lack-of-line sections, in a planned travel section of the vehicle 10 from the current position of the vehicle 10 to a position a predetermined distance ahead thereof. The detecting unit 32 also detects a widened section in which the host vehicle lane is wider than a normal lane, as one of the specific sections. Additionally, the detecting unit 32 sets sections where the host vehicle lane has left and right lane lines and is as wide as a normal lane as reference sections.

For example, to detect a one-sided-line section and a lack-of-line section, the detecting unit 32 refers to the high-precision map in the planned travel section, and thereby detects, for each of the left and right lane lines of the host vehicle lane, endpoints where the lane line is broken as nodes. For each detected node, the detecting unit 32 sets a corresponding node at a position on the other lane line whose distance from the detected node is the shortest. However, in the case that the position of the shortest distance is an endpoint of the other lane line and that this endpoint has already been associated with another node, the detecting unit 32 sets a virtual node indicating that there is no corresponding node on the other lane line. The detecting unit 32 divides the host vehicle lane into sections each of which is defined by two nodes adjoining in the lengthwise direction thereof on each of the left and right lane lines. Of these sections, the detecting unit 32 detects a section having only one of the left and right lane lines as a one-sided-line section, and detects a section lacking both lane lines as a lack-of-line section.

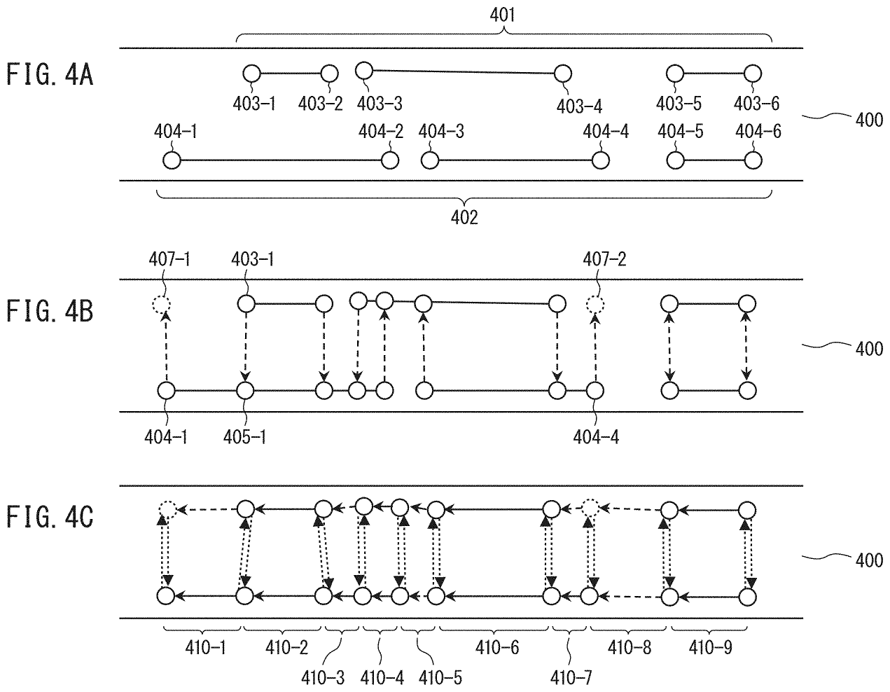

FIGS. 4A to 4C illustrates an example of detection of a one-sided-line section and a lack-of-line section. As illustrated in FIG. 4A, assume that lane lines 401 and 402 are drawn on the right and on the left of a host vehicle lane 400, respectively, in a planned travel section. In this example, both the right lane line 401 and the left lane line 402 have broken parts. For this reason, the endpoints of the lane line 401 are identified as nodes 403-1 to 403-6, and those of the lane line 402 are identified as nodes 404-1 to 404-6.

As illustrated in FIG. 4B, nodes respectively corresponding to the nodes 403-1 to 403-6 of the right lane line 401 are set at those positions on the left lane line 402 whose distances from the respective nodes are the shortest. For example, a node 405-1 is set on the left lane line as a node corresponding to the node 403-1. Similarly, nodes respectively corresponding to the nodes 404-1 to 404-6 of the left lane line 402 are set at those positions on the right lane line 401 whose distances from the respective nodes are the shortest. However, regarding the node 404-1, the position of the shortest distance is an endpoint of the right lane line 401, and this endpoint has already been associated with another node 405-1. For this reason, a virtual node 407-1 indicating that the right lane line 401 does not have a node corresponding to the node 404-1 is set. Similarly, for the node 404-4 also, a virtual node 407-2 indicating that there is no corresponding node is set.

As illustrated in FIG. 4C, of sections 410-1 to 410-9 each of which is defined by two nodes adjoining in the lengthwise direction of the host vehicle lane 400, sections having only one of the left and right lane lines are detected as one-sided-line sections. In this example, the sections 410-1, 410-3, 410-5, and 410-7 are detected as one-sided-line sections. The section 410-8 is detected as a lack-of-line section. The other sections are reference sections. A section where there is no node on either side of the host vehicle lane, e.g., a section ahead of the section 410-1, is detected as a lack-of-line section.

To detect a widened section, the detecting unit 32 refers to the high-precision map to determine the width of the host vehicle lane in the planned travel section every predetermined interval along the travel direction of the vehicle 10. The detecting unit 32 compares the width of the host vehicle lane with a predetermined width threshold every predetermined interval, and detects, as a widened section, a section where the host vehicle lane has a width greater than the width threshold. The width threshold is set at a value obtained by adding a predetermined offset value to the width of a normal lane conforming to standards of roads, and is prestored in the memory 22. The predetermined offset value may be, for example, a normal lane width multiplied by 0.3 to 0.7. Alternatively, multiple width thresholds may be set depending on standards of roads (e.g., expressways or national roads). In this case, the detecting unit 32 refers to the high-precision map to identify the standard of the road on which the vehicle 10 is traveling, loads a width threshold corresponding to the identified standard from the memory 22, and uses it for comparison with the width of the host vehicle lane. Alternatively, the detecting unit 32 may set the width threshold by adding a predetermined offset value to the average of widths of the host vehicle lane at locations in the planned travel section in which the host vehicle lane has both of left and right lane lines.

Additionally, the detecting unit 32 detects sections where the host vehicle lane has both of left and right lane lines and has a width not greater than the width threshold as reference sections.

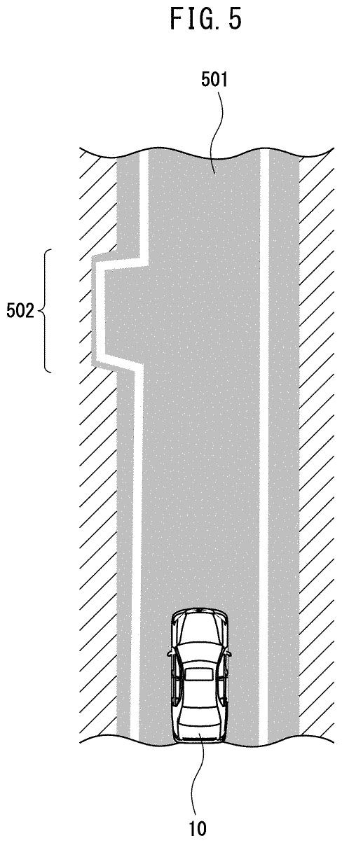

FIG. 5 illustrates an example of a widened section. In the example illustrated in FIG. 5, the vehicle 10 is traveling on a lane 501, and the lane 501 has a width greater than a width threshold in a section 502. Hence the section 502 is detected as a widened section.

The detecting unit 32 notifies the reference-trajectory setting unit 33 of information indicating the positions of the reference sections in the planned travel section of the vehicle 10 from the current position of the vehicle 10 to a position a predetermined distance ahead thereof (e.g., information indicating the positions of the endpoints of each reference section). Additionally, the detecting unit 32 notifies the trajectory setting unit 34 of information indicating the positions of the specific sections in the planned travel section of the vehicle 10 from the current position of the vehicle 10 to a position a predetermined distance ahead thereof (e.g., information indicating the positions of the endpoints of each specific section) and information indicating the types of the specific sections.

Upon receiving the information indicating the positions of the reference sections in the planned travel section from the detecting unit 32, the reference-trajectory setting unit 33 sets planned trajectories of the reference sections (hereafter, “reference trajectories”). For example, the reference-trajectory setting unit 33 sets a reference trajectory so that the ratio of the distance from the left lane line of the host vehicle lane to the reference trajectory (first distance) to the distance from the right lane line of the host vehicle lane to the reference trajectory (second distance) will be a predetermined ratio. The predetermined ratio is set, for example, at 1:1. In this case, the reference trajectory is set on the center of the host vehicle lane. However, the predetermined ratio is not limited to 1:1, and may be set so that the reference trajectory will be on the left or right in the host vehicle lane, depending on the circumstances around the vehicle 10. More specifically, when a large-size vehicle, such as a truck or a bus, is traveling near the vehicle 10 on an adjoining lane on the right of the host vehicle lane, the reference trajectory is preferably set on the left in the host vehicle lane so that the space between the vehicle 10 and the large-size vehicle will not be too narrow. In such a case, the predetermined ratio is set, for example, at 4:6 or 3:7 so that the first distance will be shorter than the second distance. When a large-size vehicle is traveling on an adjoining lane on the left of the host vehicle lane, the reference trajectory is preferably set on the right in the host vehicle lane. In such a case, the predetermined ratio is set, for example, at 6:4 or 7:3 so that the second distance will be shorter than the first distance.

The reference-trajectory setting unit 33 can detect a vehicle traveling around the vehicle 10 and determine whether the detected vehicle is a large-size vehicle, for example, by inputting an image obtained by the camera 3 into a classifier. As such a classifier, the reference-trajectory setting unit 33 may use a DNN having a CNN architecture as described in relation to the lane identifying unit 31. In the case that the type of the detected vehicle is a large-size vehicle, the reference-trajectory setting unit 33 can determine whether the large-size vehicle is traveling on an adjoining lane by comparing the position of an object region representing the large-size vehicle in the image with the positions of lane lines. Since the position of the bottom of the object region is assumed to be the position where the large-size vehicle is in contact with the road surface, the position of the bottom of the object region in the image is assumed to be the direction, viewed from the camera 3, to the position where the large-size vehicle is in contact with the road surface. Hence the reference-trajectory setting unit 33 can estimate the distance to the large-size vehicle, based on internal parameters of the camera 3, such as its mounted position and focal length, and the position of the bottom of the object region representing the large-size vehicle. When a large-size vehicle is traveling on an adjoining lane and the estimated distance from the vehicle 10 to the large-size vehicle is not greater than a predetermined distance, the reference-trajectory setting unit 33 may set the predetermined ratio so that the reference trajectory will be on the side of the lane line opposite to the adjoining lane with respect to the center of the host vehicle lane, as described above.

Alternatively, when the current position of the vehicle 10 is included in a reference section, the reference-trajectory setting unit 33 may set the predetermined ratio, based on the current position of the vehicle 10. For example, the reference-trajectory setting unit 33 may set, as the predetermined ratio, the ratio of the distance from the current position of the vehicle 10 to the left lane line of the host vehicle lane to the distance from the current position of the vehicle 10 to the right lane line of the host vehicle lane. This allows for setting a reference trajectory so that the position of the vehicle 10 will remain unchanged in the widthwise direction of the lane.

The reference-trajectory setting unit 33 notifies the trajectory setting unit 34 and the vehicle control unit 35 of information indicating the reference trajectories set for the reference sections (e.g., the ratio of the first distance to the second distance and the width of the lane in each reference section).

Upon receiving the information indicating the positions and types of the specific sections in the planned travel section from the detecting unit 32 and receiving the information indicating the reference trajectories for the reference sections from the reference-trajectory setting unit 33, the trajectory setting unit 34 sets planned trajectories for the respective specific sections.

For example, for each one-sided-line section of the specific sections, the trajectory setting unit 34 sets at least one candidate trajectory including a first candidate trajectory located a first offset distance closer to the center of the host vehicle lane from an existing one of the lane lines of the host vehicle lane. Of the at least one set candidate trajectory, the trajectory setting unit 34 sets a candidate trajectory having a minimum average variation in curvature at parts connected to planned trajectories of the sections ahead of and behind the one-sided-line section as the planned trajectory of the one-sided-line section. In the present embodiment, the sections ahead of and behind a one-sided-line section are reference sections or specific sections of a type other than a one-sided-line section. The first offset distance is set, for example, at the first distance from the left lane line to the reference trajectory or the second distance from the right lane line to the reference trajectory in the reference section closest to the one-sided-line section of interest. In the case that the one-sided-line section has a left lane line, the trajectory setting unit 34 may set the first offset distance at the first distance from the left lane line to the reference trajectory in the reference section closest to the one-sided-line section of interest. Similarly, in the case that the one-sided-line section has a right lane line, the trajectory setting unit 34 may set the first offset distance at the second distance from the right lane line to the reference trajectory in the reference section closest to the one-sided-line section of interest. This increases the possibility of setting a candidate trajectory smoothly connected to planned trajectories of the sections ahead of and behind the one-sided-line section, even when the reference trajectory is set so that the vehicle 10 will travel on the right or left in the host vehicle lane.

For each lack-of-line section of the specific sections, the trajectory setting unit 34 detects the left and right edges of the road on which the vehicle 10 is traveling. For example, the trajectory setting unit 34 may detect the positions of the left and right road edges in the lack-of-line section of the road on which the vehicle 10 is traveling, based on the current position of the vehicle 10 and the high-precision map. Alternatively, as described in relation to the lane identifying unit 31, the trajectory setting unit 34 may input an image obtained by the camera 3 into a classifier to detect the left and right road edges, or receive the result of detection of curbstones of the left and right road edges from the lane identifying unit 31 and identify the positions of the left and right road edges, based on the result of detection.

The trajectory setting unit 34 sets candidate trajectories including a first candidate trajectory located a second offset distance closer to the center of the road from the left edge of the road and a second candidate trajectory located the second offset distance closer to the center of the road from the right edge of the road. Of the set candidate trajectories, the trajectory setting unit 34 sets a candidate trajectory having a minimum average variation in curvature at parts connected to planned trajectories of the sections ahead of and behind the lack-of-line section as the planned trajectory of the lack-of-line section. In the present embodiment, the sections ahead of and behind a lack-of-line section are reference sections or specific sections of a type other than a lack-of-line section.

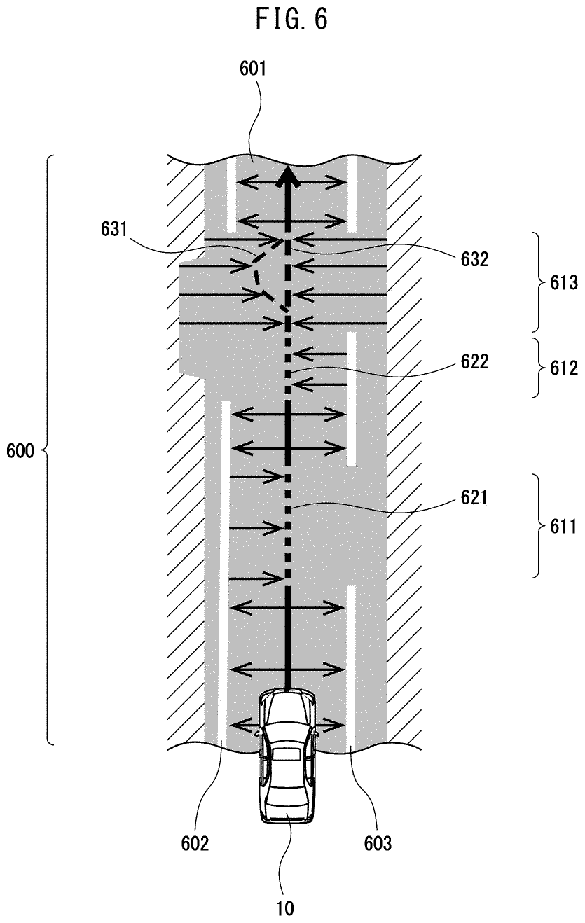

FIG. 6 is a diagram for explaining setting of planned trajectories of a one-sided-line section and a lack-of-line section. As illustrated in FIG. 6, a planned travel section 600 includes one-sided-line sections 611 and 612 in which a left or right lane line of a host vehicle lane 601 on which the vehicle 10 is traveling is broken, and a lack-of-line section 613 lacking both the left and right lane lines of the host vehicle lane 601. In the one-sided-line section 611 having only a left lane line 602 of the lane lines, a candidate trajectory 621 is set a first offset distance closer to the center of the host vehicle lane 601 from the left lane line 602. Similarly, in the one-sided-line section 612 having only a right lane line 603, a candidate trajectory 622 is set the first offset distance closer to the center of the host vehicle lane 601 from the right lane line 603. In this example, since the number of candidate trajectories set in each one-sided-line section is one, the set candidate trajectory will be the planned trajectory of the corresponding one-sided-line section.

In the lack-of-line section 613, a first candidate trajectory 631 is set a second offset distance closer to the center of the road from the left edge of the road, and a second candidate trajectory 632 is set the second offset distance closer to the center of the road from the right edge of the road. In this example, the second candidate trajectory 632 has a smaller average variation in curvature than the first candidate trajectory 631 at parts connected to planned trajectories 640 of the sections ahead of and behind the lack-of-line section 613. Hence the second candidate trajectory 632 is selected as the planned trajectory of the lack-of-line section 613.

For each widened section of the specific sections, the trajectory setting unit 34 sets candidate trajectories including a first candidate trajectory located a third offset distance closer to the center of the host vehicle lane from the left lane line of the host vehicle lane and a second candidate trajectory located the third offset distance closer to the center of the host vehicle lane from the right lane line of the host vehicle lane. Of the set candidate trajectories, the trajectory setting unit 34 sets a candidate trajectory having a minimum average variation in curvature at parts connected to planned trajectories of the sections ahead of and behind the widened section as the planned trajectory of the widened section. In the present embodiment, the sections ahead of and behind a widened section are reference sections or specific sections of a type other than a widened section. The third offset distance is set, for example, at the first distance from the left lane line to the reference trajectory or the second distance from the right lane line to the reference trajectory in the reference section closest to the widened section of interest. The trajectory setting unit 34 may set the third offset distance for the first candidate trajectory based on the left lane line at the first distance, and the third offset distance for the second candidate trajectory based on the right lane line at the second distance. This increases the possibility of setting the first or second candidate trajectory smoothly connected to planned trajectories of the sections ahead of and behind the widened section, even when the reference trajectory is set so that the vehicle 10 will travel on the right or left in the host vehicle lane.

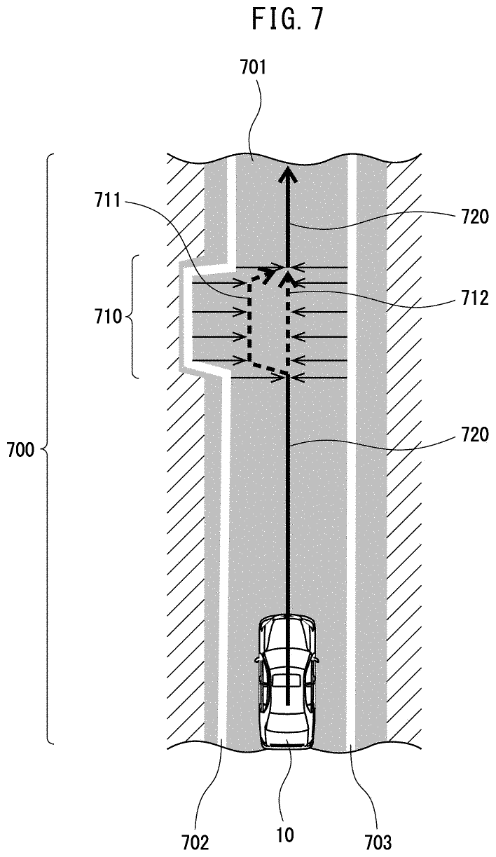

FIG. 7 is a diagram for explaining setting of a planned trajectory of a widened section. As illustrated in FIG. 7, a planned travel section 700 includes a widened section 710 in which a host vehicle lane 701 on which the vehicle 10 is traveling is wider than the other parts. In the widened section 710, a first candidate trajectory 711 is set at a position a third offset distance from a left lane line 702, and a second candidate trajectory 712 is set at a position the third offset distance from a right lane line 703. In this case, the second candidate trajectory 712 has a smaller average variation in curvature than the first candidate trajectory 711 at parts connected to planned trajectories 720 of the sections ahead of and behind the widened section 710. Hence the second candidate trajectory 712 is selected as the planned trajectory of the widened section 710.

According to a modified example, for a one-sided-line section and a lack-of-line section, the trajectory setting unit 34 may set, of the set candidate trajectories, a candidate trajectory having a minimum average offset distance along the direction perpendicular to the travel direction of the vehicle 10 at parts connected to planned trajectories of the sections ahead and behind as the planned trajectory of the one-sided-line section or the lack-of-line section. Similarly, for a widened section, the trajectory setting unit 34 may set, of the set candidate trajectories, a candidate trajectory having a minimum average offset distance along the direction perpendicular to the travel direction of the vehicle 10 at parts connected to planned trajectories of the sections ahead and behind as the planned trajectory of the widened section.

Additionally, the trajectory setting unit 34 may set a candidate trajectory different from those described above for each widened section, one-sided-line section, and lack-of-line section. For example, for a widened section, a one-sided-line section, or a lack-of-line section, the trajectory setting unit 34 may set a trajectory connecting planned trajectories of the sections ahead of and behind this section by the shortest route, as one of candidate trajectories. Setting such an additional candidate trajectory allows the trajectory setting unit 34 to further increase the possibility of smoothly connecting the planned trajectory of a specific section to planned trajectories of the sections ahead of and behind this section.

Additionally, different types of specific sections may connect in some cases. For example, with reference to FIG. 6 again, the one-sided-line section 612 and the lack-of-line section 613 connect. In such a case, at least one of the sections ahead of and behind a specific section is a section other than a reference section, in which a planned trajectory can be set based on lane lines of this section. Thus, in the case that different types of specific sections connect, the trajectory setting unit 34 may set the priority order of setting planned trajectories, depending on the types of the specific sections, and set planned trajectories according to this priority order for the respective specific sections. For example, the trajectory setting unit 34 may assign the highest priority to widened sections, the second highest priority to one-sided-line sections, and the lowest priority to lack-of-line sections. In this case, the trajectory setting unit 34 may set planned trajectories in the order of widened sections, one-sided-line sections, and lack-of-line sections (if reference sections are included, in the order of reference sections, widened sections, one-sided-line sections, and lack-of-line sections) in accordance with the above-described method. Alternatively, the trajectory setting unit 34 may assign the highest priority to one-sided-line sections, the second highest priority to widened sections, and the lowest priority to lack-of-line sections. In this case, the trajectory setting unit 34 may set planned trajectories in the order of one-sided-line sections, widened sections, and lack-of-line section (if reference sections are included, in the order of reference sections, one-sided-line sections, widened sections, and lack-of-line section) in accordance with the above-described method. Since setting planned trajectories in order from a section where at least one of lane lines of the host vehicle lane can be used for setting a planned trajectory, the trajectory setting unit 34 can connect the planned trajectories more smoothly in the whole planned travel section.

Alternatively, in the case that different types of specific sections connect, the trajectory setting unit 34 may set planned trajectories in order from one of the specific sections closer to a reference section in accordance with the above-described method. Alternatively, in the case that different types of specific sections connect, the trajectory setting unit 34 may set planned trajectories in order from one of the specific sections closer to the current position of the vehicle 10 in accordance with the above-described method. In these cases also, the trajectory setting unit 34 can connect the planned trajectories more smoothly in the whole planned travel section.

Upon setting the planned trajectories for the respective specific sections, the trajectory setting unit 34 connects the planned trajectories set for the respective sections in the planned travel section to set a planned trajectory of the whole planned travel section. To this end, the trajectory setting unit 34 may execute a smoothing process on the trajectory obtained by connecting the planned trajectories set for the respective sections in the planned travel section to set a planned trajectory of the whole planned travel section.

The trajectory setting unit 34 passes the planned trajectory of the whole planned travel section to the vehicle control unit 35.

The vehicle control unit 35 executes automated driving control of the vehicle 10 so that the vehicle 10 will travel along the planned trajectory. For example, the vehicle control unit 35 determines a target acceleration of the vehicle 10 according to the planned trajectory and the current speed of the vehicle 10 measured by a vehicle speed sensor (not illustrated), and sets the degree of accelerator opening or the amount of braking so that the acceleration of the vehicle will be equal to the target acceleration. The vehicle control unit 35 then determines the amount of fuel injection according to the set degree of accelerator opening, and outputs a control signal depending on the amount of fuel injection to a fuel injector of the engine of the vehicle 10. Alternatively, the vehicle control unit 35 outputs a control signal depending on the set amount of braking to the brake of the vehicle 10.

When changing the travel direction of the vehicle 10 in order for the vehicle 10 to travel along the planned trajectory, the vehicle control unit 35 determines the steering angle of the vehicle 10 according to the planned trajectory and outputs a control signal depending on the steering angle to an actuator (not illustrated) controlling the steering wheel of the vehicle 10.

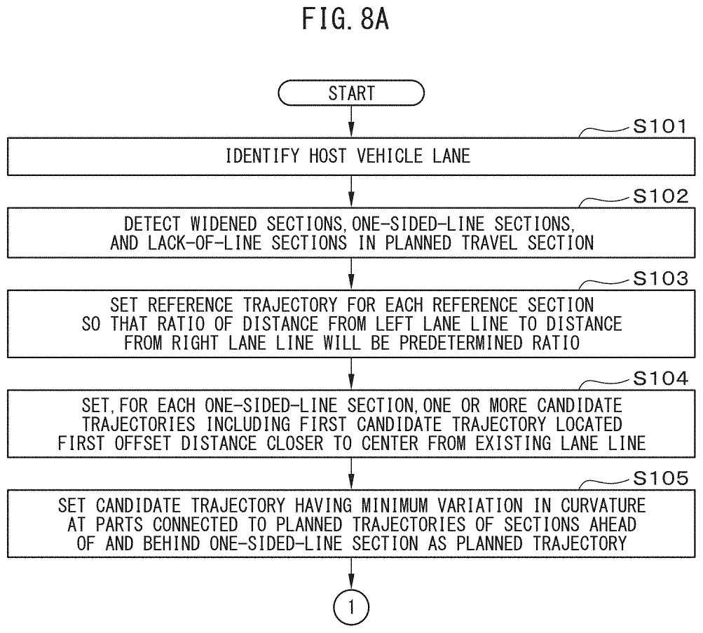

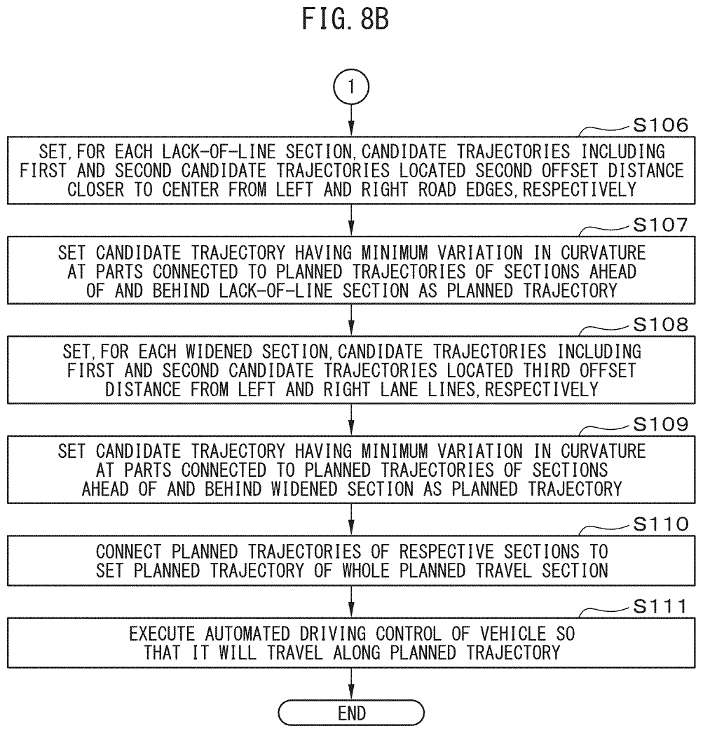

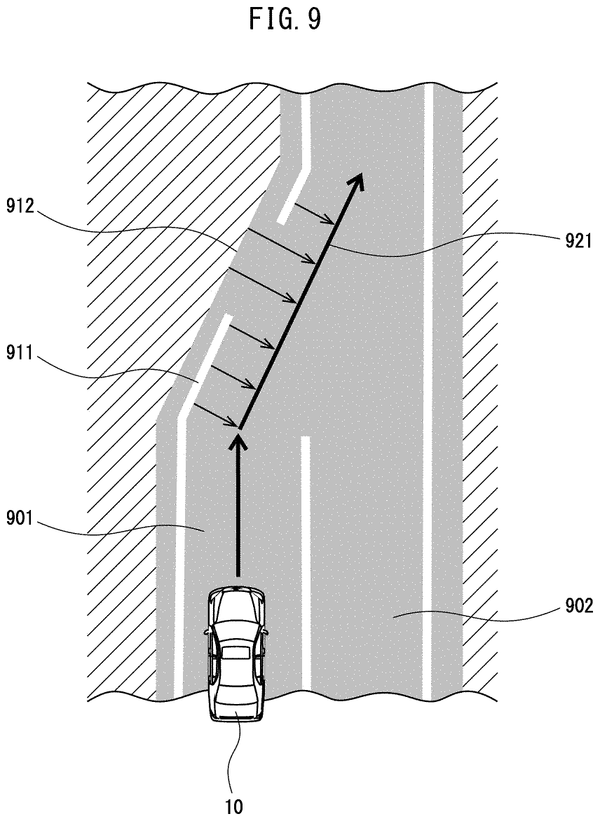

FIGS. 8A and 8B are an operation flowchart of the vehicle control process including the planned-trajectory setting process, executed by the processor 23. The processor 23 may execute the vehicle control process in accordance with the following operation flowchart every predetermined period. Of the steps in the following operation flowchart, the process of steps S101 to S110 is included in the planned-trajectory setting process.

The lane identifying unit 31 of the processor 23 identifies the lane on which the vehicle 10 is traveling, i.e., the host vehicle lane (step S101). In the planned travel section, the detecting unit 32 of the processor 23 detects widened sections, one-sided-line sections, and lack-of-line sections of the host vehicle lane, and detects the other sections as reference sections (step S102).

For each reference section in the planned travel section, the reference-trajectory setting unit 33 of the processor 23 sets a reference trajectory so that the ratio of the first distance from the left lane line of the host vehicle lane to the reference trajectory to the second distance from the right lane line of the host vehicle lane to the reference trajectory will be a predetermined ratio (step S103).

For each one-sided-line section in the planned travel section, the trajectory setting unit 34 of the processor 23 sets at least one candidate trajectory including a first candidate trajectory located a first offset distance closer to the center of the host vehicle lane from an existing one of the lane lines of the host vehicle lane (step S104). Of the at least one set candidate trajectory, the trajectory setting unit 34 sets a candidate trajectory having a minimum average variation in curvature at parts connected to planned trajectories of the sections ahead of and behind the one-sided-line section as the planned trajectory of the one-sided-line section (step S105).

Additionally, for each lack-of-line section in the planned travel section, the trajectory setting unit 34 sets candidate trajectories including a first candidate trajectory located a second offset distance closer to the center of the road, on which the vehicle 10 is traveling, from the left edge of the road and a second candidate trajectory located the second offset distance closer to the center of the road from the right edge of the road (step S106). Of the set candidate trajectories, the trajectory setting unit 34 sets a candidate trajectory having a minimum average variation in curvature at parts connected to planned trajectories of the sections ahead of and behind the lack-of-line section as the planned trajectory of the lack-of-line section (step S107).

Additionally, for each widened section in the planned travel section, the trajectory setting unit 34 sets candidate trajectories including a first candidate trajectory located a third offset distance closer to the center of the host vehicle lane from the left lane line of the host vehicle lane and a second candidate trajectory located the third offset distance closer to the center of the host vehicle lane from the right lane line of the host vehicle lane (step S108). Of the set candidate trajectories, the trajectory setting unit 34 sets a candidate trajectory having a minimum average variation in curvature at parts connected to planned trajectories of the sections ahead of and behind the widened section as the planned trajectory of the widened section (step S109). In step S105, S107, and S109, the trajectory setting unit 34 may set, of the set candidate trajectories, a candidate trajectory having a minimum average offset distance along the direction perpendicular to the travel direction of the vehicle 10 at parts connected to planned trajectories of the sections ahead and behind as the planned trajectory of the corresponding section, as described above.

The trajectory setting unit 34 connects the planned trajectories of the reference sections, the widened sections, the one-sided-line sections, and the lack-of-line sections to set a planned trajectory of the whole planned travel section (step S110). The vehicle control unit 35 of the processor 23 executes automated driving control of the vehicle 10 so that the vehicle 10 will travel along the planned trajectory (step S111). Then, the processor 23 terminates the vehicle control process.

As has been described above, the apparatus for setting a planned trajectory detects one-sided-line sections and lack-of-line sections in a planned travel section from the current position of a vehicle to a position a predetermined distance ahead thereof. For each one-sided-line section, the apparatus sets one of candidate trajectories at a position a predetermined offset distance closer to the center of the host vehicle lane from an existing one of the lane lines. For each lack-of-line section, the apparatus sets candidate trajectories so as to include a candidate based on the left edge of the road on which the vehicle is traveling and a candidate based on the right edge thereof. Of the set candidates, the apparatus sets, for each one-sided-line section and lack-of-line section, a candidate trajectory having a smaller variation in curvature or a smaller offset at parts connected to the planned trajectory in sections ahead of and behind this section as the planned trajectory of the one-sided-line section or the lack-of-line section. For this reason, the apparatus can set a smooth planned trajectory along the host vehicle lane even if a section lacks one or both of left and right lane lines of the host vehicle lane.

According to a modified example, the detecting unit 32 may detect a merge or split section in which the host vehicle lane merges with another lane or another lane splits from the host vehicle lane in the planned travel section. In this case also, the detecting unit 32 can detect a merge or split section by referring to the current position of the vehicle 10 and the high-precision map, as in the embodiment. For example, in the case that the host vehicle lane merges with another lane, the detecting unit 32 may detect, as a merge or split section, a section from a location where, of the left and right lane lines of the host vehicle lane, the lane line closer to the other lane merges with a lane line of the other lane to a location where the host vehicle lane and the other lane merge into one lane, i.e., to a location where the width of the lanes becomes a width of one lane. Similarly, in the case that another lane splits from the host vehicle lane, the detecting unit 32 may detect, as a merge or split section, a section from a location where the other lane starts splitting from the host vehicle lane to a location where a lane line between the host vehicle lane and the other lane appears.

In this case, the trajectory setting unit 34 may set a planned trajectory of a merge or split section at a position a fourth offset distance closer to the side on which a merge or split occurs, i.e., to the center of the host vehicle lane from the lane line or road edge opposite to the other lane. The fourth offset distance may be set, for example, at the first distance from the left lane line to the reference trajectory or the second distance from the right lane line to the reference trajectory in the reference section closest to the merge or split section of interest, similarly to the first offset distance for a one-sided-line section.

FIG. 9 illustrates an example of a planned trajectory of a merge or split section according to this modified example. In this example, a lane 901 on which the vehicle 10 is traveling merges with another lane 902 adjoining on the right. Thus, in a merge or split section of the lane 901 and the other lane 902, a planned trajectory 921 is set at a position a fourth offset distance closer to the other lane 902 from a left lane line 911 of the lane 901, or from a left road edge 912 thereof in the case that the lane line 911 does not exist. Such setting of a planned trajectory of a merge or split section results in a planned trajectory being set as a smooth trajectory along a lane in the merge or split section and the sections ahead of and behind this section.

A computer program for achieving the functions of the processor 23 of the ECU 5 according to the embodiment or modified examples may be provided in a form recorded on a computer-readable and portable medium, such as a semiconductor memory, a magnetic recording medium, or an optical recording medium.

As described above, those skilled in the art may make various modifications according to embodiments within the scope of the present invention.

What is claimed is:

1. An apparatus for setting a planned trajectory, comprising:
a processor configured to:
identify a travel lane on which a vehicle is traveling,
detect, as a specific section, a section lacking at least one of left and right lane lines of the travel lane of the vehicle in a planned travel section from a current position of the vehicle to a position a predetermined distance ahead thereof,
set at least one candidate of a planned trajectory to be traveled by the vehicle in the specific section, the at least one candidate including a candidate based on an existing one of the lane lines or a road edge, and
set, of the set candidate, a candidate having a minimum variation in curvature or a minimum offset distance in a direction perpendicular to a travel direction of the vehicle at parts connected to the planned trajectory in sections ahead of and behind the specific section as the planned trajectory of the specific section.

2. The apparatus according to claim 1, wherein the processor detects, as the specific section, a one-sided-line section in which one of left and right lane lines of the travel lane of the vehicle is broken; and
the processor sets, in the one-sided-line section, the at least one candidate including a first candidate set at a position a first offset distance closer to the center of the travel lane from an unbroken one of left and right lane lines, and
sets, of the set candidate, a candidate having a minimum variation in curvature or a minimum offset distance in a direction perpendicular to a travel direction of the vehicle at parts connected to the planned trajectory in sections ahead of and behind the one-sided-line section as the planned trajectory of the one-sided-line section.

3. The apparatus according to claim 2, wherein the processor further detects, as the specific section, a lack-of-line section in which both of left and right lane lines of the travel lane of the vehicle are broken; and
the processor sets, in the lack-of-line section, the plurality of candidates including a first candidate and a second candidate, the first candidate being set at a position a second offset distance closer to the center of a road being traveled by the vehicle from the left edge of the road, the second candidate being set at a position the second offset distance closer to the center of the road from the right edge of the road, and
sets, of the set candidates, a candidate having a minimum variation in curvature or a minimum offset distance in a direction perpendicular to a travel direction of the vehicle at parts connected to the planned trajectory in sections ahead of and behind the lack-of-line section as the planned trajectory of the lack-of-line section.

4. The apparatus according to claim 3, wherein in the case that the one-sided-line section and the lack-of-line section connect, the processor sets the planned trajectory of the one-sided-line section earlier than the planned trajectory of the lack-of-line section.

5. The apparatus according to claim 1, wherein the processor further detects a widened section in which the travel lane has a width greater than a predetermined width threshold; and
the processor sets, in the widened section, the plurality of candidates including a first candidate and a second candidate, the first candidate being set at a position a third offset distance closer to the center of the travel lane of the vehicle from a left lane line of the travel lane, the second candidate being set at a position the third offset distance closer to the center of the travel lane of the vehicle from a right lane line of the travel lane; and of the set candidates, and
sets a candidate having a minimum variation in curvature or a minimum offset distance in a direction perpendicular to a travel direction of the vehicle at parts connected to the planned trajectory in sections ahead of and behind the widened section as the planned trajectory of the widened section.

6. The apparatus according to claim 1, wherein in the planned travel section, the processor further detects a merge or split section in which the travel lane of the vehicle and another lane merge or split, and
the processor sets, in the merge or split section, the planned trajectory at a position a fourth offset distance closer to the center of the travel lane from a lane line or a road edge opposite to the other lane.

7. A method for setting a planned trajectory, comprising:
identifying a travel lane on which a vehicle is traveling;
detecting, as a specific section, a section lacking at least one of left and right lane lines of the travel lane of the vehicle in a planned travel section from a current position of the vehicle to a position a predetermined distance ahead thereof;
setting at least one candidate of a planned trajectory to be traveled by the vehicle in the specific section, the at least one candidate including a candidate based on an existing one of the lane lines or a road edge; and
setting, of the set candidate, a candidate having a minimum variation in curvature or a minimum offset distance in a direction perpendicular to a travel direction of the vehicle at parts connected to the planned trajectory in sections ahead of and behind the specific section as the planned trajectory of the specific section.
